(19) United States
(12) Patent Application Publication
(10) Pub. No.: US 2003/0233243 A1
(43) Pub. Date: Dec. 18, 2003

(54) Systems and methods for cross site capital asset sharing

(76) Inventor: Donna K. Officer, San Jose, CA (US)

Correspondence Address: SUGHRUE MION, PLLC, 2100 PENNSYLVANIA AVENUE, N.W., WASHINGTON, DC, 20037, US

(21) Appl. No.: 10/170,696

(22) Filed: Jun. 14, 2002

(51) Int. Cl. G06F 17/60

(52) U.S. Cl. 705/1; 705/10; 705/7

(57) ABSTRACT

A cross-site capital asset sharing method facilitates the sharing of capital assets between groups in an organization, such as between different sites within a division of a large corporation, thereby reducing capital expenses by forgoing purchases of capital assets that are available for sharing within the organization. Information regarding cost savings due to forgoing the purchase of assets that are shared is collected. Aggregate cost savings is calculated and used by management in rewarding participation in the savings initiative, planning for future capital purchases and in other management actions.

### BACKGROUND OF THE INVENTION

1. Field of the Invention

The invention relates to methods, apparatuses and articles of manufacture for sharing capital assets within an organization.

2. Description of the Related Art

Organizations, such as large corporations, spend vast sums of money every year purchasing capital assets. For example, these large corporations often will purchase millions of dollars worth of information technology (IT) equipment such as mainframe computers, specialized server computers, computing platforms for various operating system architectures, etc., as well purchasing many other types of capital assets. However, such organizations often will purchase a capital asset despite a similar asset being available elsewhere within the organization because that similar asset is unknown to the group making the purchase. For corporations that have many divisions, with each division possibly having several different sites, personnel at one site may require use of a capital asset but are unaware of a similar asset located either at another site within the same division or within another division of the corporation. Because the group needing the asset does not know of the availability of the similar asset elsewhere, that group will plan for and purchase the capital asset despite the similar asset being available for use. Groups needing capital assets submit proposed capital purchase plans during a regular business planning cycle to purchase a quantity of capital assets that will meet the groups' needs during the year. Often, however, those capital purchase plans include plans to purchase a quantity of equipment that exceeds the actual needs either division-wide or corporate-wide. Those purchase plans exceed the actual needs because similar assets are available elsewhere in the division or corporation but go unused. In many instances the result of those unused assets not being shared is over spending on capital assets that in fact are not needed.

Often, the personnel responsible for identifying the needs for a capital asset and the personnel responsible for acquiring that asset do not have the information necessary to identify a similar asset elsewhere within the organization that may be available for use. For example, in an IT organization, oftentimes managers of software development groups require certain computing assets such as server computers, specialized operating systems, and certain peripherals in order to develop a software product. However, those managers are not informed of assets that are available at other sites.

While the groups within the organization can identify the assets that they need, corporate management has not rewarded them for finding ways to save costs by reducing unnecessary purchases of capital assets by seeking out underutilized assets elsewhere in the corporation. This lack of reward likely is a prime reason that personnel responsible for specifying and obtaining capital assets do not seek out similar assets that already are owned by the corporation but are located elsewhere in the corporation such as at a different site within the same division or even in another division. As a result, without this reward for reducing expense by reducing capital expenditures, potential savings resulting from sharing underutilized assets are not realized.

Not only has there been no such reward for individuals participating in the capital asset acquisition process, no systems have been put in place to simplify and improve the process of identifying underutilized assets that could be used in place of a capital purchase. Further, in a conventional corporate environment it has been easier to follow the traditional process of planning for and purchasing new capital assets than it is to seek out underutilized assets elsewhere in the division or corporation.

Although instances of sharing assets within organizations certainly have occurred, those sharing arrangements most likely have occurred at the same site due to informal and chance contacts between workers who happen to learn of an underutilized piece of equipment elsewhere at the site. No known cross-site initiatives that address the problem of simplifying the process of finding underutilized capital assets and providing incentive to personnel who are responsible for obtaining such assets have been implemented to save a corporation, or other organization, money by reducing capital equipment purchases.

Accordingly, there is a need for a cross-site system for identifying capital assets that can be shared between groups within an organization and for motivating personnel responsible for identifying and obtaining those assets to seek out a sharing agreement to reduce capital expenditure costs.

### SUMMARY OF THE INVENTION

A method of sharing assets within an organization, includes sharing the assets between groups in an organization, wherein the participants within the groups initiate the sharing. A cost savings is determined that results from said sharing, and the participants' contributions to the sharing are acknowledged based on the cost savings. The method further includes notifying the group's management of the participants' contributions to the sharing and of the cost savings, wherein the participants' contributions can be acknowledged by giving them an award having a value based on the determined cost savings.

An amount of savings due to sharing an asset between groups within an organization can also be determined according to the following method. An asset sharing message, which can be transmitted in an email message, is received that includes an identification of the shared asset, asset cost information, and participant information identifying participants involved in sharing the asset. In response to receiving that message cost savings accounting information is entered into a worksheet based on the received asset sharing message, where the worksheet can be a computer readable spreadsheet. A cost savings associated with sharing the asset is calculated based on the cost savings accounting information entered into the worksheet, where the cost savings can be the foregone cost associated with purchasing the asset if the asset was not available for sharing. The organization's management is notified of the calculated cost savings associated with sharing the asset and of the participants involved in sharing the asset.

The method can further include generating a cost savings report based on the calculated cost savings, and sending the cost savings report to management. Further still, the method can include sending a message, such as an email message, to the people identified in the participant information of the asset sharing message expressing appreciation for savings attributable to at least one of the groups involved in sharing the asset. A reward for the participants can be based on the calculated cost savings.

Features and advantages of the invention will become apparent upon consideration of the following descriptions and descriptive figures of specific embodiments thereof. While these descriptions go into specific details of the invention, it should be understood that variations may and do exist and would be apparent to those skilled in the art based on the descriptions herein.

### BRIEF DESCRIPTION OF THE DRAWINGS

FIG. 1 is an organization chart of coordinators involved in a cross-site capital asset (CASI) sharing program.

FIG. 2 shows a hierarchical organizational relationship between various roles in a CASI program.

FIG. 3 is message flow diagram illustrating message flows between various roles in a CASI program.

FIG. 4 is system level diagram illustrating a computer network infrastructure that supports a CASI program.

FIGS. 5A and 5B are flowcharts illustrating a sharing process used in a CASI program.

FIG. 6 illustrates a spreadsheet for tracking asset sharing information.

FIG. 7 is a flow diagram showing four participant recognition processes.

FIG. 8 illustrates an example of a reward used in the recognition processes.

FIG. 9 shows message flows between general and site coordinators, and management.

### DETAILED DESCRIPTION

The embodiments described below are described with reference to the above drawings, in which like reference numerals designate like components.

A cross-site capital asset sharing initiative (CASI), referred to here as a CASI program, is useful in a large organization, such as a corporation, to reduce expenses associated with purchasing capital assets by facilitating the sharing of underutilized assets already owned by the organization thereby forgoing a further purchase of the asset. A CASI program can reduce capital asset expenses by facilitating the sharing of capital assets among different groups within the organization. Examples of these groups include divisions within a corporation or among sites within a division or even across divisions. For example, the sharing can occur between groups located at distant locations from one another such as between hardware laboratory sites or across different functional areas. Any group within the organization that purchases capital assets can benefit from participating in the CASI program and can reap the benefits of the sharing program described here. The participating groups (e.g., laboratories, functional units, etc.) can reside at different sites or other physical locations. Hence, the cross-site aspect of the sharing program potentially can include all divisions or sub-groupings within the organization. Such a sharing program, however, is not limited to cross-site sharing among groups located at distant locations, but also can be used by a single group or at a single site.

The sharing of capital assets among participants at these different sites eliminates the need to purchase additional equipment that, but for the sharing, would be purchased in the normal course of acquiring capital assets. The sharing of assets also satisfies the original business requirement for the asset, as only those assets that are available for shared use, and not presently being used by the group having the original business requirement, are made available for sharing.

Any type of sharing diverse assets that forgoes purchases can be included in a CASI program, i.e., sharing of subcomponents, entire hardware systems, assets on loan, complete transfers, new purchases, used equipment at another site, etc. The sharing transactions can be of short term duration, e.g., less than one year, or of long term duration, e.g., for a year or more.

The foregone, avoided costs of purchasing additional equipment are a direct result of sharing in the CASI program. Such sharing produces a tangible, concrete cost savings to the organization using the CASI program. The names of the participants for each instance of savings along with those foregone costs in the CASI program are recorded. From that information the cost savings can be calculated for use by management in planning for capital purchases, evaluating the cost effectiveness of groups within the organization, and rewarding employees who participate in the CASI program and initiate the savings.

A CASI program can be implemented either manually, in a computerized manner, or by a combination of both, depending on the needs of the organization to manage sharing of assets. The CASI program also can provide a continuous (i.e., 24/7, 365 day) dynamic search capability for assets to satisfy specific needs. For example, rather than being limited to searching for assets that are available for sharing for predetermined periods of time needs, such as on a per week, month, quarter, year, etc. basis, or for assets tied to a particular business process other than a need, assets can be search for and located based on a variety of criteria. The program is flexible and comprehensive enough to incorporate time specific events or uses during a particular reoccurring period of time. Additionally, as an incentive to participation in the CASI program, names of the participants are recorded and reported to management so that the participants' efforts can be recognized for cost savings resulting from the sharing.

The CASI program tracks and accounts for cost savings resulting from foregoing capital hardware asset purchases from any source and/or means within an organization. The assets that can be shared range from subcomponent parts to entire hardware systems. An aspect of the CASI program that motivates its use in participation in the program is recognition of the participants.

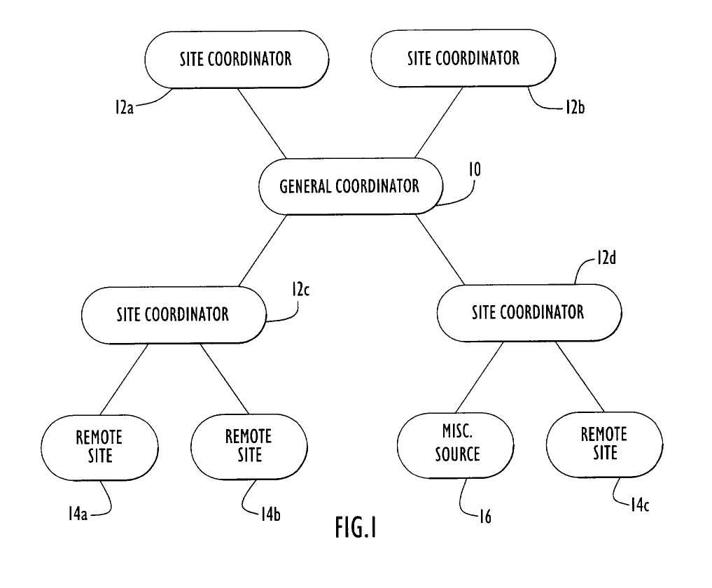

Certain roles are needed to implement the CASI program, as illustrated in FIG. 1. A general coordinator 10 operates as a central role in the CASI system. Site coordinators 12a, 12b, 12c and 12d are responsible for operating the CASI program at various sites throughout the organization, with one site coordinator, or more, at each site. Certain sites may have associated with them remote sites, in which case a site coordinator, such as site coordinator 12c, also acts as the coordinator for the remote site, such as for remote sites 14a and/or 14b. Site coordinator 12d, shown in FIG. 1, operates as a coordinator for remote site 14c, and also can operate as a coordinator responsible for other miscellaneous sources of assets 16 that can be shared. The miscellaneous sources can be any sources of capital savings within an organization or an affiliate organization that are not currently tracked by the CASI program, but are subsequently tracked to include all units or subunits that result in cost savings effected by the sharing, loan or transfer of hardware assets.

An example of a miscellaneous source 16 arises in the case of a support group within a large organization. The organization includes sites, such as development laboratories, that have coordinators for the site to request capital assets needed for the development activities. These requests can be directed to these support groups, such as a functional group like a finance group that approves the requests for purchase of capital assets. The functional groups role within the CASI program can vary depending on the needs of the organization. For example, a functional group, such as a finance department, can require that a requestor from a laboratory first use the CASI process before approving the asset purchase. In another instance, the functional group itself can issue a request within the CASI system by sending a CASI request for the asset requested to be purchased. If the asset is available for sharing, the purchase request is denied and the requestor put in contact with the appropriate site coordinator having control of the available asset. If the functional group determines that the asset is not available, the purchase request would be granted in a conventional manner.

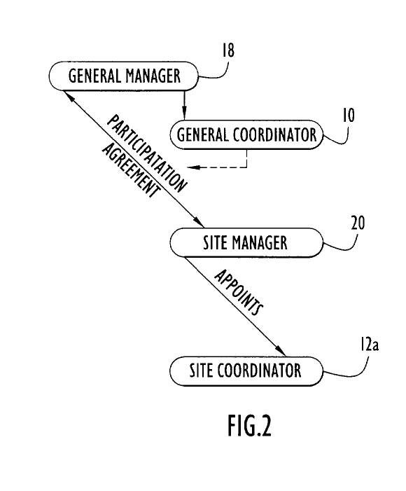

A CASI program is implemented through the management of the organization, as illustrated in FIG. 2. Within an organization, such as a division of a corporation, a general manager 18 for that division appoints a CASI general coordinator 10 who reports to the general manager. The general coordinator operates as the overall coordinator for the CASI program throughout the organization. The general manager for the organization initiates participation agreements with various site managers 20 who agree to obligations and conditions of the sharing program. The site manager 20 who is in charge of a site facility within the division, in turn appoints a site coordinator 12a for that site. Alternatively, the general coordinator 10 can obtain the agreement from the site managers or other functional managers to participate in the CASI program if the general manager 18 delegates that authority to the general manager 10. The site coordinator 12a is responsible for coordinating the sharing of the site's assets with other sites, and for requesting shared assets from other sites.

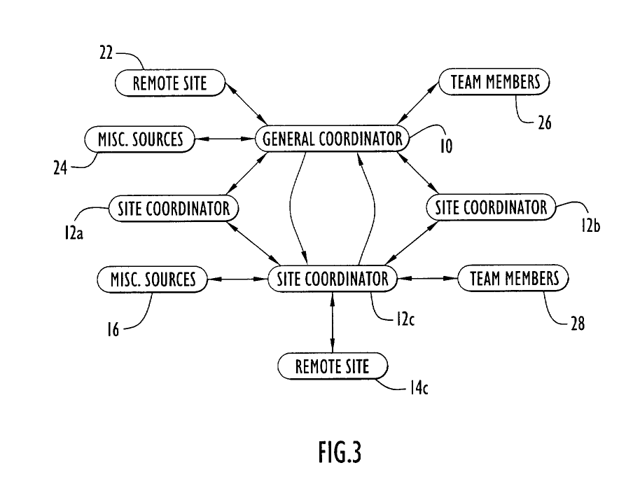

FIG. 3 illustrates the flow of information and messages between the various site coordinators and the general coordinator in a CASI program. When a participating site needs equipment, the site coordinator, such as site coordinator 12a, contacts the general coordinator 10 with a request for a particular asset. The general coordinator in turn queries the other site coordinators (12a, 12b and 12c) for availability of the requested asset. Site coordinators also can query other site coordinators directly and allow other personnel at their site to contact other site coordinators directly to identify sharing opportunities. For each sharing transaction the site coordinator at the site having the asset communicates with the general coordinator, such as by sending an asset sharing information message by e-mail, for example, that contains information concerning the assets shared, the period of time over which the asset will be shared, the participants involved in sharing the asset, and information concerning the present cost of the asset being shared. These asset sharing messages are illustrated by the arrows shown in FIG. 3.

For each sharing transaction the general coordinator 10 upon receiving the asset sharing message sends a message expressing appreciation on behalf of the organization to the participants involved in initiating the sharing of the asset. The general coordinator also enters the information in the asset sharing message into a tracking program that accumulates and consolidates cost savings information for all sharing transactions within the organization. An example of such a tracking program is a spreadsheet program executing on a computer. The tracking program transforms the savings information from the asset sharing message by combining it with cost savings information gathered from other CASI transactions.

The general coordinator periodically distributes updates to site coordinators and to management informing them of cost savings resulting from the CASI program, such as the aggregated cost savings on an organization-wide basis or on a site-specific basis. FIG. 3 further illustrates that the general coordinator 10 can operate in the same capacity as a site coordinator in that the general coordinator may control assets at the site where the general coordinator is located and can operate as a site coordinator for sharing with others in the organization.

Team members 26 associated with the same site as the general coordinator can communicate directly with the general coordinator 10 to initiate sharing requests. The general coordinator in that instance operates as a site coordinator and sends out a sharing request to the other site coordinators for a specified asset. Similarly, team members 28 can contact a site coordinator 12c for the site at which they are located to make the request for the asset.

The site coordinator 12c can be responsible for assets at a remote site 14c associated with the division's main site where the site coordinator is located. Site coordinator 12c handles requests for assets controlled by the remote site 14c as well as handling requests from a remote site 14c for assets needed by that remote site.

Miscellaneous sources 16 and 24 represent either miscellaneous sources of assets available for sharing that are not associated with any specific site within the organization or assets located at miscellaneous groups within the organization not associated with, for example, a laboratory site. The miscellaneous sources 16 and 24 can also represent various functional groups within an organization, such as a finance group responsible for approving requests for purchase of capital assets. These functional groups can either make requests on behalf of requestors desiring to purchase capital assets, or can act as a gatekeeper to the purchase of assets by requiring the requesters first submit a CASI request to determine if the asset is available for shared use.

The flow of information depicted in FIG. 3 can be facilitated by the use of electronic messaging systems, such as networked computers that communicate by way of messages, including email messages. The use of networked computers provides for virtually instantaneous communications between disparate subdivisions within an organization. This instantaneous communication allows for an efficient and an effective communication of CASI related information between the general coordinators, the site coordinators and the various team members involved in sharing an asset.

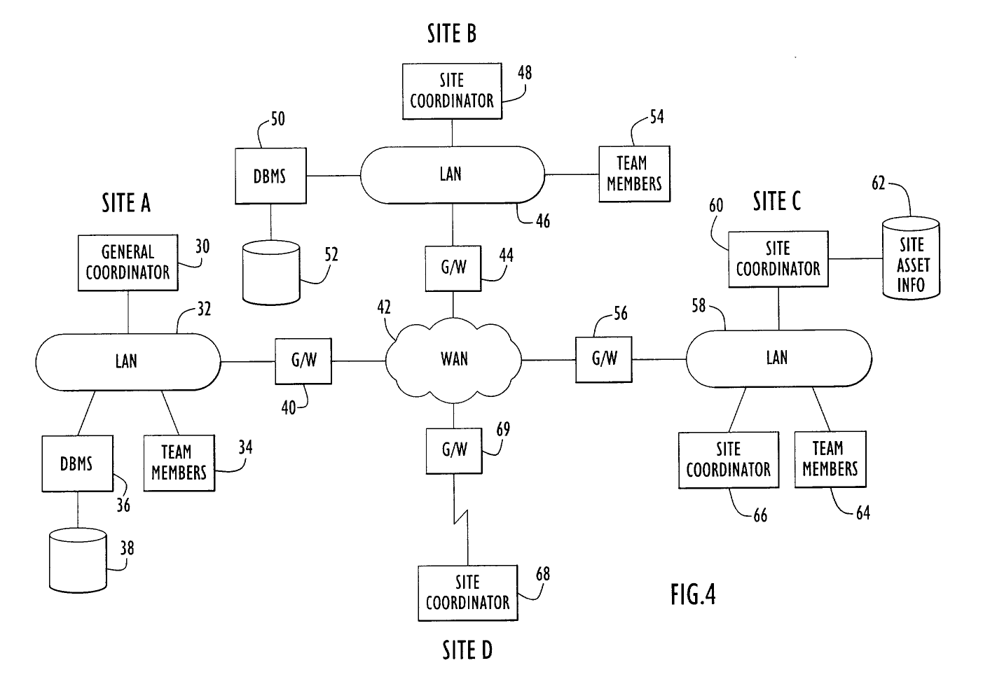

FIG. 4 shows a representative, non-limiting example of a networked computing system that can be used to implement a CASI program. The example computing system shown in FIG. 4 illustrates four sites, namely, site A, site B, site C and site D, connected by way of a wide area network (WAN). Referring to FIG. 4, a general coordinator's computer 30 is used by the general coordinator located at site A to send and receive messages including requests for shared assets, and to access information concerning available assets within the organization. The general coordinator's computer 30 is connected to a local area network (LAN) 32. The LAN provides local connectivity between team members 34 and the general coordinator located at the same site, namely, site A. The general coordinator can store the CASI information in a data storage facility located in a variety of places using a variety of well-known information processing tools. One such tool is a database management system (DBMS) 36 that includes a data store 38. Here, the DBMS is shown connected to the LAN 32, however, the DBMS can be located on the general coordinator's computer 30 or even remotely from site A. Further, the data storage facility for storing the CASI information need not be a DBMS but can include other data storage tools, such as a spreadsheet used in a spreadsheet program. The general coordinator communicates with the DBMS by way of the LAN 32. Similarly, the team members 34 communicate with the general coordinator by way of email messages sent over the LAN. A gateway (G/W) 40 is connected to LAN 32 and provides access to the WAN 42 for communicating over long distances with other sites. Alternatively, the team members can send CASI request messages directly to other site coordinators to request the desired capital asset.

Another site participating in the CASI program is site B. A site coordinator for site B has a computer 48 to facilitate sending and receiving CASI messages. The site coordinator's computer 48 can be connected to a LAN 46 servicing site B. The site coordinator for site B keeps information concerning assets that are controlled by site B and that are available for shared use. That information is held in a storage facility such as DBMS 50 having a data store 52. Again, the storage facility can be network connected by way of a LAN, or can be part of the site coordinator's computer 48, or can be located remotely from site B. Team members at site B also have computers 54 connected to LAN 46. The team members' computers 54 are used by the site B team members to communicate with the site B site coordinator to request assets for sharing and also notify the site coordinator of assets that are available for sharing that are under the control of the team members. The site B LAN 46 is connected to a gateway 44 for connectivity over the WAN 42. Alternatively, the team members can send CASI request messages directly to other site coordinators to request the desired capital asset.

Many different distant sites can be connected by way of the WAN 42 to participate in the CASI program. This is depicted in FIG. 4 by another site, site C, connected to WAN 42 by way of a gateway 56. A LAN 58 servicing site C provides connectivity for site C. Site C has a site coordinator with a computer 60 connected to the LAN 58. In this instance, the site coordinator's computer 60 is connected to, or includes, a data store 62 that holds asset information for site C. Team members located at site C have computers 64 connected to the LAN 58 for communicating with the site coordinator for site C. Again, the team members can send email messages, or other type of messages, to the site coordinator informing the site coordinator of assets that are available for sharing or to request the sharing of assets located at site C or at another site within the organization. Alternatively, the team members can send CASI request messages directly to other site coordinators to request the desired capital asset.

Site C also shows the arrangement in which more than one site coordinator is connected to the computing network by way of the same LAN 58. In this case, site coordinator computer 66 can be a back-up computer or a computer for an alternative site coordinator for site C. Further still, the site coordinator computer 66, shown in FIG. 4, can represent connectivity for a remote site that uses the networking facilities of site C.

At site D, a LAN is not used and a computer 68 for the site coordinator at site D is connected to the WAN 42 by way of a gateway 69. This type of connection might be used for a small remote site that does not use a local area network.

By connecting the computers used by the people in the various CASI roles, the general coordinator, site coordinators and team members can communicate their requests to share assets virtually instantaneously which can promote the use and efficiency of sharing of assets. The use of these computing resources also facilitates keeping track of the shared resources and the participants involved in the sharing using computerized messages such as emails or other messages capable of being transmitted over a network and stored in a computerized data management system such as a DBMS. The information concerning the shared assets including information about the people involved in initiating and implementing the sharing is readily stored and manipulated by conventional information processing tools.

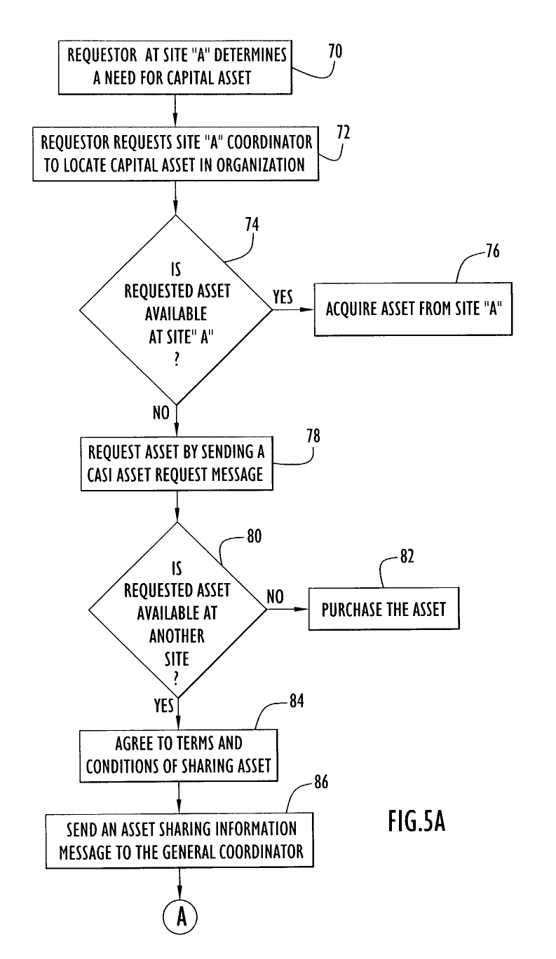

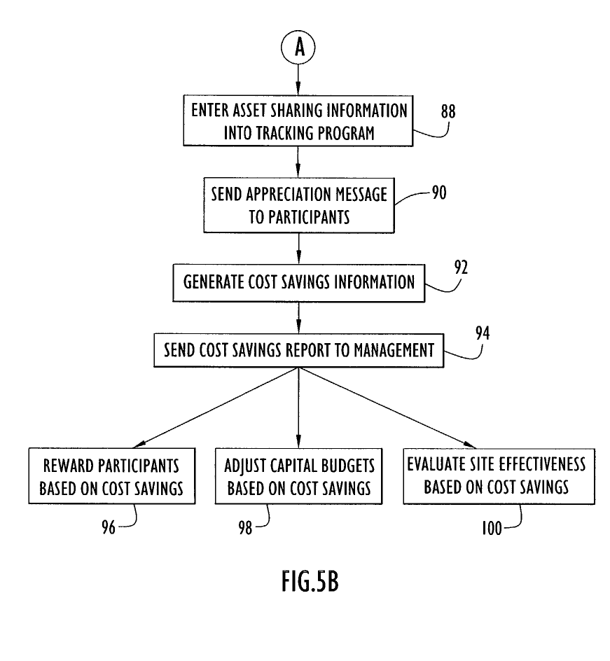

A process for sharing a capital asset is illustrated by the flowcharts in FIGS. 5A and 5B. Referring to FIG. 5A, in operation 70 a requester at a site, such as site A, determines that a need exists for a particular asset. The requester can be any employee at the site who has a need for the asset. The requestor contacts the site coordinator for site A and requests the coordinator to determine if the required asset is available within the organization for sharing 72. The site coordinator for site A first determines if the asset is available within the site 74. If so, the asset is acquired within the site and used 76. However, if site A does not have the asset available, the site coordinator sends an asset sharing request message to the general coordinator 78. Alternatively, if the site coordinator knows or suspects that the asset may be available at another site, the site coordinator sends the sharing request message directly to the site coordinator for that other site.

If the request message is sent to the general coordinator, the general coordinator determines if the asset is available at another site 80 by relaying the request to one or more of the other site coordinators. A site coordinator upon receiving such a request, checks the site's inventory of capital assets to determine whether the request can be met. If the requested asset is not available at any other site, the requesting site purchases the asset 82. However, if a site coordinator determines that the requested asset is available for sharing, that site coordinator contacts the requesting site coordinator to reach an agreement about the terms for sharing the asset 84. Upon reaching an agreement, the site coordinator in possession of the asset to be shared sends an asset sharing message containing information concerning the sharing, as discussed above, to the general coordinator 86. Whenever two site coordinators agree to share a capital asset, the site coordinator having possession of the asset sends an asset sharing information message to the general coordinator with the information necessary for tracking the sharing of the asset. Flow from the process depicted in FIG. 5A follows connector “A” to the flowchart in FIG. 5B.

Upon receiving the asset sharing message, the general coordinator enters the information in that message into a CASI tracking program 88. The general coordinator then returns a message expressing appreciation to the site coordinator in possession of the asset and the participants at that site 90. Similarly, the general coordinator 10 sends a message of appreciation to the site coordinator who requested the asset, expressing appreciation to that site coordinator and the participants at that site for participating in the sharing program 90.

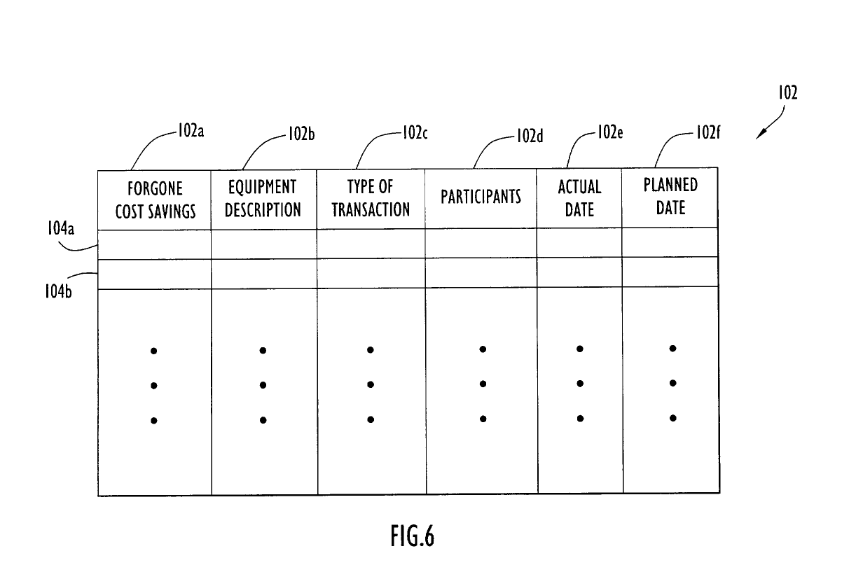

Upon a site coordinator sending an asset sharing information message to the general coordinator, the general coordinator inputs the information from that message into a tracking device, such as a computer spreadsheet 102, as illustrated in FIG. 6. The cost savings information in the asset sharing message includes the current cost of the asset that would have had to be expended if the sharing transaction had not occurred. This cost savings represents the current foregone cost of an asset if it had to be purchased by one of the groups involved in sharing. Upon receiving the asset sharing message, the general coordinator records the cost savings information one time for each piece of equipment that is shared between locations or functions, per recognition period. For example, as shown in FIG. 6, for an asset that is shared during a particular recognition period, the forgone cost savings 102a is entered into row 104a of spreadsheet 102. Similarly, a description of the asset, or equipment, is entered into column 102b and a type of transaction 102c is entered, such as whether the asset is being shared, is on loan, etc. In column 102d, information concerning the participants of the sharing transaction are recorded. Column 102e is where the actual date of sharing is recorded, which is input by a subsequent message sent by the sharing participants when the sharing actually begins. A planned date column 102f is where the information from the asset sharing message concerning the planned date of sharing is recorded. Each instance of sharing is recorded in a separate row in the spreadsheet, such as in rows 104a and 104b.

Referring again to FIG. 5B, upon entering the cost savings information into the tracking device, the cost savings associated with the various instances of sharing is calculated 92. Cost savings can be calculated in many different ways depending on the needs of management. Various reports can be generated from this calculated cost savings information, and those reports are sent to management 94. Management then uses the information in those report to take tangible, concrete actions, such as, for example, rewarding participants of the CASI program based on the cost savings 96, adjusting capital budgets based on the calculated cost savings 98, and evaluating the expenses of a site based on that sites capital cost savings 100. Examples of calculations of cost savings includes a total sum of the foregone asset purchase expenses. The foregone purchase expenses can be further calculated based on site, functional group, etc. The savings also can be calculated over various periods of time, such as by quarter, by year, etc. Cost savings by category of asset can be calculated from the savings information. Statistical calculations can be performed on the savings information to provide various analyses of the cost savings information. Many other variations on the cost savings calculations that can be performed will be understood by the skilled artisan.

An example of a practical application of the CASI process is management's recognition of the participants' contributions to cost savings due to sharing an asset between different groups within the organization. By recognizing the participant's contributions to the savings, employees become motivated to search for and discover ways of reducing costs by sharing equipment between sites, as opposed to simply ordering new equipment when a need arises. A useful and tangible result of this process is in saving the organization the costs associated with purchasing new equipment or other assets.

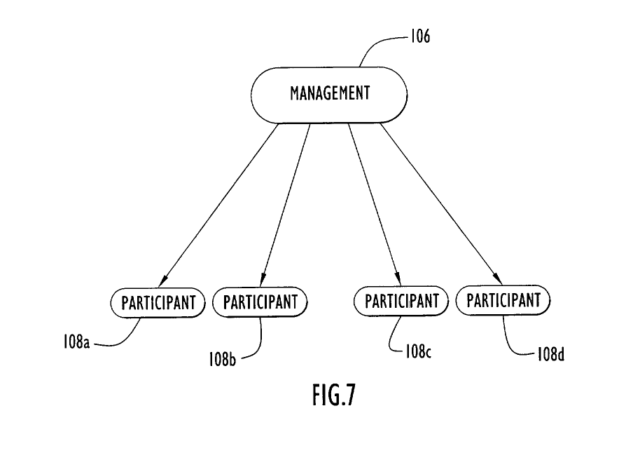

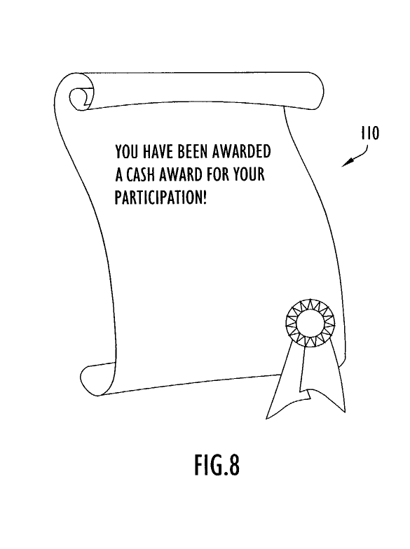

FIG. 7 shows a conceptual diagram of the recognition process. Management 106 within the organization, or within any of the groups participating in the CASI process, recognizes participants 108a through 108d by providing the participants with rewards. The reward can take many forms, an example of which is reward 10 shown in FIG. 8. Here, the reward is a certificate of participation in the program indicating a cash award based on the calculated savings resulting from the asset shared by the recognized participants. A monetary award can be based on a percentage of the cost savings associated with sharing the asset. This award amount can be determined based on a percentage, determined by management, of the calculated total cost savings associated with sharing of the asset. Alternatively still, the award can be based on a total aggregate savings associated with the site, where all the participants in CASI at that site are given an award based on that aggregate savings. Alternatively, management can recognize the participants by providing them other types of rewards, such as the cost savings being a component of an employee's performance evaluation. Further savings and participation in the CASI program will result from recognizing the participants, and this is yet another useful, concrete and tangible result of the CASI process.

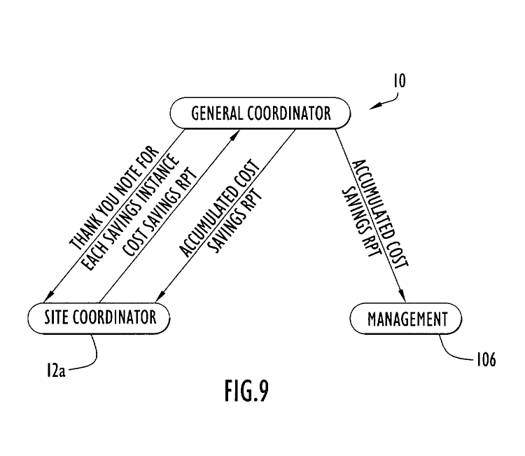

FIG. 9 shows message flows between a general coordinator 10, a site coordinator 12a and management 106. The site coordinator 12a, for each instance of sharing an asset, sends to the general coordinator 10 a cost savings message or report. The general coordinator 10 enters the cost savings information from that message into the tracking program, such as a computer based spreadsheet program, to calculate cost savings for the site. The general coordinator 10 then sends an accumulated cost savings report both to the site coordinator 12a and to the site management 106 to inform them of the accumulated cost savings for the site. The general coordinator also sends a thank you note, which can be by way of an e-mail message or a handwritten message, to the site coordinator for each instance of asset sharing, and hence savings. The site coordinator can then forward the thank you note to the participants at the site. The general coordinator can also send the thank you notes directly to the participants as well as to the site coordinator.

In certain applications the roles of the general coordinator and site coordinator can be augmented with computers to provide a continuous (i.e., 24/7, 365 day/yr.) dynamic asset search capability. Accordingly, in such an instance FIG. 4 illustrates a networked computer arrangement in which the role of general coordinator is automated by a computer program executing in computer 30. Similarly, the site coordinator roles also can be automated by use of computers, such as computers 48, 60 and 68. A site coordinator, using a computer connected to a network, such as the Internet or an intranet used within the organization, communicates with the general coordinator's computer 30. The general coordinator's computer 30 can operate as a network server responsive to requests made by the site coordinators. For example, the general coordinator server 30 can receive search requests for assets, and based on the requested information automatically directs the request to the appropriate site coordinator(s) most likely to have the asset. The general coordinator then receives a response from the other site coordinator(s) to which the original request was directed and forwards that response to the requesting site coordinator. Alternatively, the general coordinator, in response to receiving a request for an asset, automatically broadcasts a message to the all of the other site coordinators querying them as to whether their site has the requested asset available. Any responses to the broadcast request can be returned to the requesting site coordinator.

In yet another alternative, the general coordinator can have a central repository of information held in the server that describes assets that other site coordinators have designated as available for sharing. However, such a centralized system might be limited to use in organizations in which the number of assets available for sharing is not so large as to be unmanageable. In the instance of a centralized system the general coordinator responds to the requesting site coordinator with information about available resources.

The site coordinators' computers 48, 60 and 68 can be programmed to respond to such requests from the general coordinator to search an information base containing information about assets available at their site. If such an asset is available, the site coordinator's computer automatically responds to the general coordinator's request. The site coordinators' computers can be automated to receive updates from participants at the site who supply asset information to the site coordinator when an asset is available for sharing. For example, the site coordinator's computer can include a well-known HTML interface, acting as a server for participants at the site to allow those participants to enter asset information. In this manner, an automated CASI system can provide a continuous dynamic search capability.

Having described apparatuses, articles of manufacture and methods of managing the sharing of capital assets, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

What is claimed is:

1. A method of sharing an asset within an organization, comprising:
sharing an asset between groups in the organization, wherein the participants within the groups initiate the sharing;
determining a cost savings resulting from said sharing; and
acknowledging the participants' contributions to the sharing based on the determined cost savings.

2. The method of claim 1, further comprising notifying management of the groups of the participants' contributions to the sharing and of the cost savings.

3. The method of claim 1, wherein the participants' contributions are acknowledged by giving the participants an award having a value based on the determined cost savings.

4. The method of claim 1, further comprising automatically determining if the asset is available for sharing by querying an information base containing information identifying assets as available for sharing.

5. A method of sharing an asset, comprising:
sending a request for an asset;
determining if the asset is designated as available for sharing;
agreeing to share the asset in response to determining it is available;
recording cost savings information associated with sharing of the asset;
calculating an aggregate cost savings based on the recorded cost savings associated with sharing the asset and cost savings associated with sharing of other assets; and
using the calculated aggregate cost savings in planning for purchase of further assets.

6. The method of claim 5, wherein the asset is shared within an organization having a general asset coordinator and the organization includes a plurality of sites each having a site coordinator, wherein a first site coordinator representing a first site within the plurality of sites sends the request for the asset to the general asset coordinator, the general asset coordinator determines if the requested asset is available for sharing, and in response to said determination the first site coordinator agrees with a second site coordinator representing a second site that controls the asset to share the asset.

7. The method of claim 6, further comprising at least one of the first and second site coordinators communicates to the general asset coordinator savings information concerning savings associated with sharing the asset.

8. The method of claim 7, wherein the savings information includes a period of time over which the asset is shared, the parties sharing the asset, a purchase cost of the shared asset.

9. The method of claim 6, further comprising the general asset coordinator sending a communication acknowledging contributions of participants associated with the sharing of the asset.

10. The method of claim 5, further comprising generating a report including the calculated aggregate cost savings and identifying participants associated with the sharing of the assets.

11. The method of claim 10, further comprising sending the report to management of the organization responsible for the first site.

12. The method of claim 5, further comprising budgeting for asset acquisitions based on the calculated aggregate cost savings.

13. The method of claim 5, wherein the request for the asset is sent using a computer based electronic mail system.

14. The method of claim 5, wherein the aggregate cost savings is calculated using a computer.

15. The method of claim 14, wherein the cost savings is recorded on a computer readable medium and the aggregate cost savings is calculated from the recorded cost savings by using a computer based spreadsheet program.

16. The method of claim 5, wherein said using the calculated aggregate cost savings in planning for purchase of further assets includes adjusting planned expenditures for purchase of capital assets based on the calculated aggregate cost savings.

17. A method of determining an amount of savings due to sharing an asset between groups within an organization, the method comprising:
receiving an asset sharing message including an identification of the shared asset, asset cost information, and participant information identifying participants involved in sharing the asset;
entering cost savings accounting information into a worksheet based on the received asset sharing message;
calculating a cost savings associated with sharing the asset based on the cost savings accounting information entered into the worksheet; and
notifying management personnel in the organization of the calculated cost savings associated with sharing the asset and of the participants involved in sharing the asset.

18. The method of claim 17, further comprising generating a cost savings report based on the calculated cost savings, and sending the cost savings report to said management personnel.

19. The method of claim 17, further comprising sending a message to the people identified in the participant information of the asset sharing message expressing appreciation for savings attributable to at least one of the groups involved in sharing the asset.

20. The method of claim 17, wherein the worksheet is readable by a spreadsheet computer program executing on a computer.

21. The method of claim 17, further comprising determining a reward for the participants based on the calculated cost savings.

22. The method of claim 21, wherein said determining a reward includes determining a monetary reward in proportion to the calculated cost savings.

23. The method of claim 21, wherein said determining a reward includes determining at least one of the participants' performance evaluation at least in part based on the calculated cost savings.

24. The method of claim 17, wherein the calculated cost savings is an aggregate cost savings that includes a cost savings resulting from the sharing of the asset.

25. The method of claim 24, wherein the groups are laboratory sites within a corporate entity.

26. The method of claim 25, wherein the calculated cost savings is an aggregate cost savings associated with one of said groups.

27. The method of claim 26, wherein the groups involved in sharing the asset are located at different sites within the corporation.

28. The method of claim 24, wherein the calculated cost savings is an aggregate cost savings associated with at least one of the participants.

29. The method of claim 17, wherein the asset sharing message is an email message.

30. The method of claim 17, further comprising using the calculated cost savings in planning for purchase of further assets.

31. The method of claim 17, wherein the cost savings is the foregone cost associated with purchasing the asset if the asset was not available for sharing.

32. An apparatus for tracking savings associated with sharing assets, comprising:
means for receiving an asset sharing message including an identification of the shared asset, asset cost information, and participant information identifying participants involved in sharing the asset;
means for entering cost savings accounting information into a worksheet based on the received asset sharing message;
means for calculating a cost savings associated with sharing the asset based on the cost savings accounting information; and
means for notifying management personnel in the organizations of the calculated cost savings associated with sharing the asset and of participants involved in sharing the asset.

33. A computer program product embodied on a computer-readable medium of instructions, for determining an amount of savings due to sharing an asset between organizations, the computer program product comprising:
program instructions for receiving an asset sharing message including an identification of the shared asset, asset cost information, and participant information identifying participants involved in sharing the asset;
program instructions for entering cost savings accounting information into a worksheet based on the received asset sharing message;
program instructions for calculating a cost savings associated with sharing the asset based on the cost savings accounting information; and
program instructions for notifying management personnel in the organizations of the calculated cost savings associated with sharing the asset and of participants involved in sharing the asset.

34. A method of managing the sharing of a plurality of diverse assets located at different and distant locations, wherein information concerning each of the plurality of assets is recorded in an asset sharing list, the method comprising:
determining, in response to a request from a first one of the distant locations for an asset located at a second distant location, if the requested asset is available for sharing by consulting the asset sharing list;
sharing the requested asset in response to determining that the asset is available for sharing.

35. The method of claim 34, wherein the asset sharing list is recorded on a computer-readable medium and the availability of the asset is determined by querying the asset sharing list.

36. The method of claim 35, wherein said determining if the asset is available for sharing is performed in response to receiving a request for use of the asset.

37. The method of claim 36, wherein the request is transmitted via a computer data network.

38. The method of claim 35, further comprising receiving an asset sharing message indicating that the asset is being shared and including information identifying the shared asset, and in response thereto, updating the asset sharing list with said information identifying the shared asset and to indicate that the asset is being shared.

39. The method of claim 38, further comprising sending a message of appreciation to participants involved in sharing the asset.

40. The method of claim 38, wherein the asset sharing message includes information regarding cost savings resulting from sharing the asset and said updating the asset sharing list includes recording the cost savings information, and the method further comprises generating a cost savings report based on the recorded cost savings information.

41. A method of sharing a plurality of diverse assets located at different locations, comprising:
recording information concerning the availability for use of the plurality of diverse assets; and
managing, based on the recorded information, assignment of time for use at a first location of at least one of the plurality of diverse assets located at a second location.

42. The method of claim 41, wherein the plurality of diverse assets are owned by an organization having a plurality of sites, and the first and second locations are different sites within the organization.

43. The method of claim 41, further comprising recording cost savings information associated with sharing the assets, and managing asset expenditures based on the recorded cost savings information.

44. A method of sharing a plurality of diverse assets located at different distant locations, wherein information concerning availability for use of the plurality of the diverse assets is recorded in an asset list, the method comprising:
receiving a request from a requester for use of an asset meeting specified criteria;
identifying, based on the recorded information, an asset among the plurality of assets that meets the specified criteria, is available for use, and is controlled by an asset holder; and managing sharing of the identified asset between the requester and the asset holder.

45. The method of claim 44, wherein the plurality of diverse assets are owned by an organization having a plurality of sites, and the requestor is located at a first site and the identified asset is located at a second site, wherein the first and second sites are different sites within the organization.

46. The method of claim 45, further comprising recording cost savings information associated with sharing the assets, and managing asset expenditures based on the recorded cost savings information.
